(19) United States
(12) Patent Application Publication
(10) Pub. No.: US 2019/0225207 A1
(43) Pub. Date: Jul. 25, 2019

(54) Fluid Transfer Assembly for Motorcycles

(71) Applicant: GOODRIDGE USA, INC., Torrance, CA (US)

(72) Inventor: Richard Vanstone, Devon (GB)

(21) Appl. No.: 15/932,561

(22) PCT Filed: Sep. 27, 2017
(86) PCT No.: PCT/US17/53617

§ 371 Date: Mar. 15, 2018

(51) Int. Cl. B60T 17/04; F16L 37/14; F16L 41/02

(52) U.S. Cl. CPC B60T 17/043; F16L 33/30; F16L 41/02; F16L 37/14

(57) ABSTRACT

A distribution assembly for brake fluid pressure lines employs a housing block having a cylindrical bore therethrough and a receiving detent disposed into the housing block about the cylindrical bore. The peripheral surface of the receiving detent comprises a first series of outwardly arcuately curved surfaces alternating with a second series of inwardly curved surfaces. A rigid male connecting member comprising an integral fluid conduit and positioning member is adapted to be selectively received and secured to the housing block at the receiving detent. The positioning member is disposed about the terminus of the fluid conduit, the peripheral surface thereof having a multi-lobular peripheral surface adapted to be secured within the receiving detent in a manner that will allow the fluid conduit to be selectively oriented with respect to the housing block and the cylindrical bore therethrough.

### BACKGROUND OF THE INVENTION

### 1. Field of the Invention

The present invention relates to fluid transfer systems for distributing pressurized fluid for motor vehicles in general and the distribution of braking fluid for motorcycles in particular.

### 2. Prior Art

Most modern motorcycles employ disk brakes that generally operate by transferring pressurized brake fluid from the motorcycle's brake master cylinder to brake calipers to activate the front and/or rear brakes. By their nature, motorcycles can be complex systems having different physical configurations from model to model. As a result, the physical connection of the master brake cylinder to the brake calipers is primarily dependent upon the location of the master brake cylinder and brake calipers and any obstructions between the two.

The prior art describes fluid transfer systems that are used with motorcycles. The prior art describes the components of a fluid transfer system positioned between the brake master cylinder and brake calipers pistons as comprising permanently positioned and oriented fittings that are connected to the master brake cylinder and either directly to the brake calipers or to separate distribution housing block members. For the latter, distribution members are typically cuboid housing blocks having a fitting for receiving brake fluid integral with one or more internal bores to distribute the brake fluid through fittings mounted on the cuboid. The biggest problem created by the fluid transfer systems described in the prior art is the inability to manufacture a single fluid transfer system that could uniformly be employed on multiple motorcycle model having different physical configurations.

The present invention overcomes the inadequacies inherent in the prior art by providing a coupling interface between distribution housing blocks and brake line connecting members whereby the spatial orientation between a brake line connecting member and a housing block is selectable by the user which thereby permits the user to adopt the installation to overcome the physical obstacles created by the design configurations of different motorcycle models.

### SUMMARY OF THE INVENTION

The present invention provides an improved brake fluid transfer system where pressurized brake fluid is distributed from the brake fluid master cylinder to the brake calipers through an intervening distribution housing block. A connecting member used to secure a brake line hose to the housing block comprises a fluid conduit having a connecting head fitting at one end of the conduit and a brake line hose receiver at the other end of the conduit. The distribution housing block is a cuboid having opposed parallel faces. A cylindrical bore is disposed through the housing block between opposing faces of the housing block. A receiving detent is disposed into the surface of the housing block about the aperture formed by the cylindrical bore. The peripheral surface of the receiving detent comprises a first series of outwardly, arcuately curved surfaces symmetrically interleaved with a second series of inwardly curved surfaces, the interleaved first and second series of curved surfaces being symmetrically disposed about the bore. The connecting head of the connecting member fitting has a positioning key disposed about the conduit that is adapted to be engaged within the receiving detent in the housing block. The positioning key has a multi-lobular peripheral surface comprising a first series of outwardly arcuately curved surfaces and a second series of inwardly arcuately curved surfaces, the first series being symmetrically interleaved with the second series producing alternating symmetrical lobes and flutes such that the peripheral dimensions define a multi-lobular configuration similar to the receiving detent. To optimize the spacial orientation between the break line hose receiver and the physical location where brake fluid is to be delivered, the connecting member fitting can be manually rotated and then secured within the receiving detent at the optimum location selected by the user.

It is therefore an object of the present invention to provide an improved brake fluid transfer system for motorcycles.

It is another object of the present invention to provide a brake fluid transfer system for motorcycles that can be optimized when being installed on a motorcycle.

It is still yet another object of the present invention to provide a brake fluid distribution system for motorcycles that can be installed in a plurality of selectable orientations.

It is still yet another object of the present invention to provide a brake fluid transfer system for motorcycles that is simple and inexpensive to fabricate.

The novel features which are believed to be characteristic of the invention, both as to its organization and method of operation, together with further objectives and advantages thereof, will be better understood from the following description considered in connection with the accompanying drawing in which a presently preferred embodiment of the invention is illustrated by way of example. It is to be expressly understood, however, that the drawing is for the purpose of illustration and description only, and is not intended as a definition of the limits of the invention.

### BRIEF DESCRIPTION OF THE DRAWINGS

FIG. 1 is a perspective view of the present invention illustrating connecting members installed in the distributing housing block.

FIG. 2 is a side view of the distribution housing block illustrating the receiving detent.

FIG. 3 is a cross-sectional view of the distribution housing block shown in FIG. 1 taken through line 3-3 of FIG. 1.

FIG. 4 is a top, plan view of the distribution housing block shown in FIG. 1.

FIG. 5 is an enlarged partial cross-sectional view of the receiving detent disposed into the surface of the distribution housing block shown in FIG. 3.

FIG. 6 is a front perspective view of the receiving detent in the top panel of the distribution housing block.

FIG. 7 is a front perspective view of a brake line connecting member.

FIG. 8 is a cross-sectional view of the brake line connecting member shown in FIG. 7 taken through line 8-8 of FIG. 7.

FIG. 9 is a front view of the brake line connecting member shown in FIG. 7 illustrating the positioning key.

### DESCRIPTION OF THE PRESENTLY PREFERRED EMBODIMENT

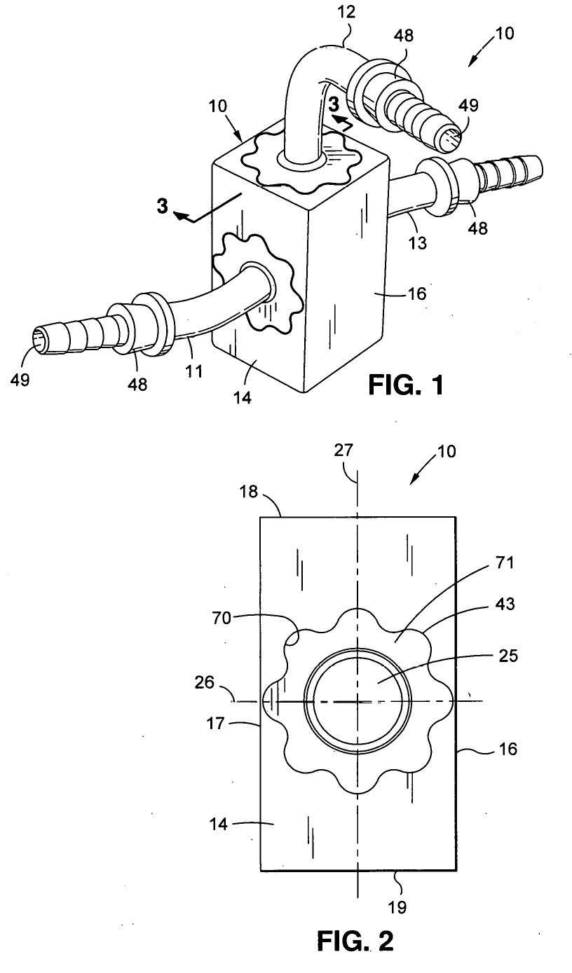

It is an object of the present invention to produce a fluid transfer system for distributing pressurized brake fluid in motorcycles that can be adapted to be installed on motorcycle models having differing physical configurations. Although the preferred embodiment of the present invention is specified for use as a fluid transfer system for motorcycles, it would be understood by persons having skill in the art to which the present invention pertains that the present invention can be employed as a fluid transfer for all motor vehicles. As shown in FIG. 1, a fluid transfer system in accordance with the present invention comprises a distribution housing block 10 and a plurality of brake line connecting members 11, 12 and 13 that will be described in detail hereinbelow.

An understanding of the structure of distribution housing block 10 can be best understood by reference to FIGS. 1-5, inclusive. Distribution housing block 10 is a cuboid having a first set of parallel opposed side panels 14 and 15, a second set of opposed side panels 16 and 17 perpendicular to the first set of side panels, and top and bottom panels 18 and 19 respectively that are in parallel spaced relation to each other and that are perpendicular to the first and second sets of side panels 14, 15, 16 and 17. Although the geometrical configuration of the distribution housing block is described as a cuboid, it would be understood by persons having skill in the art to which the invention pertains that the geometrical configuration could take any suitable geometrical form consistent with available space. Distribution housing block 10 serves as the junction at which pressurized brake line fluid is received from the master brake cylinder and distributed to the brake calipers through connecting members 11, 12 and 13.

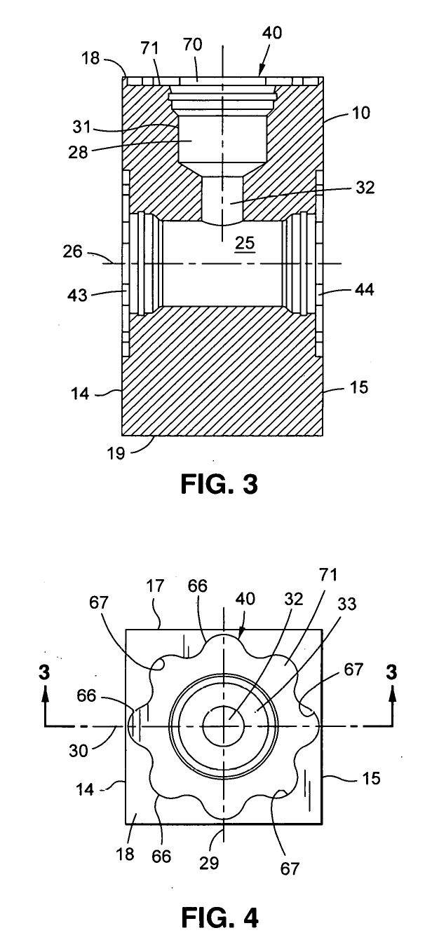

As can best seen in FIGS. 2 and 3, a cylindrical bore 25 is disposed through side panels 14 and 15, the center of cylindrical bore 25 being at the intersection of horizontal axis 26 and vertical axis 27 of side panels 14 and 15 of distribution housing block 10. As can be seen best in FIGS. 3 and 4, a central bore 28 is disposed through top surface 18 of distribution housing block 10, the center of central bore 28 being at the intersection of axes 29 and 30 of top panel 18. Central bore 28 consists of cylindrical upper section 31 and cylindrical lower section 32, section 32 being in communication with cylindrical bore 25. The upper section 31 of central bore 28 is equivalent in diameter to cylindrical bore 25. As will be described in detail hereinbelow, lower section 32 of central bore 28 is substantially equal to the internal diameter of the brake fluid conduits that comprise parts of connecting members 11, 12 and 13. Although the preferred embodiment of the present invention is described utilizing three connecting members 11, 12 and 13, it would be understood by persons having skill in the art to which the invention pertains that distribution housing block 10 can be adapted to receive additional connecting members dependent only upon available space on distribution housing block 10.

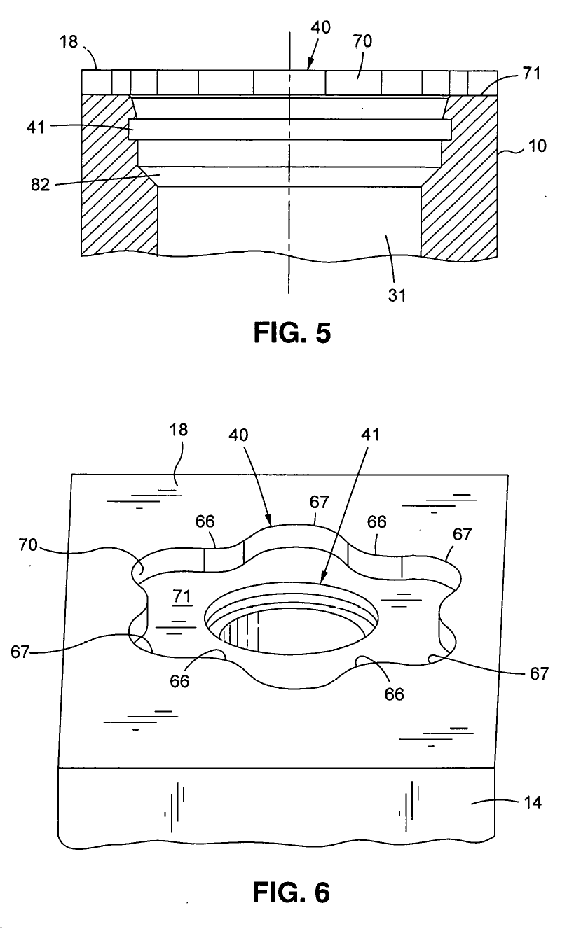

As will be described in detail hereinbelow, the interface between the distribution housing block 10 and each of the connecting members 11, 12 and 13 are identical. FIG. 5 illustrates a cross-sectional view of the upper section 31 of central bore 28 at top wall 18. A cross-sectional view of the cylindrical bore 25 adjacent its interface with opposing walls 14 and 15 are the same. At the interface with top panel 18, a receiving detent 40 is formed in a symmetrical geometrical pattern that is a mirror image to a positioning element that is part of each connecting member 11, 12 and 13. As can be seen in FIGS. 2, 3, 4 and 5, receiving detent 43 formed in the surface of side panel 14 and receiving detent 44 formed in housing block 10 at side panel 14 form the same geometric pattern as receiving detent 40. Beneath and adjacent receiving detent 40 is a sequence of adjacent machined strata that includes a retaining ring seat 41 and an O-ring receiver 42 for securing the integrity of the connections between connecting members 11, 12 and 13 and distribution housing block 10. In the same manner, the machine strata adjacent receiving detent 43 and receiving detent 44 are identical to those shown in FIG. 5, including a retaining ring seat 41 and an O-ring receiver 42.

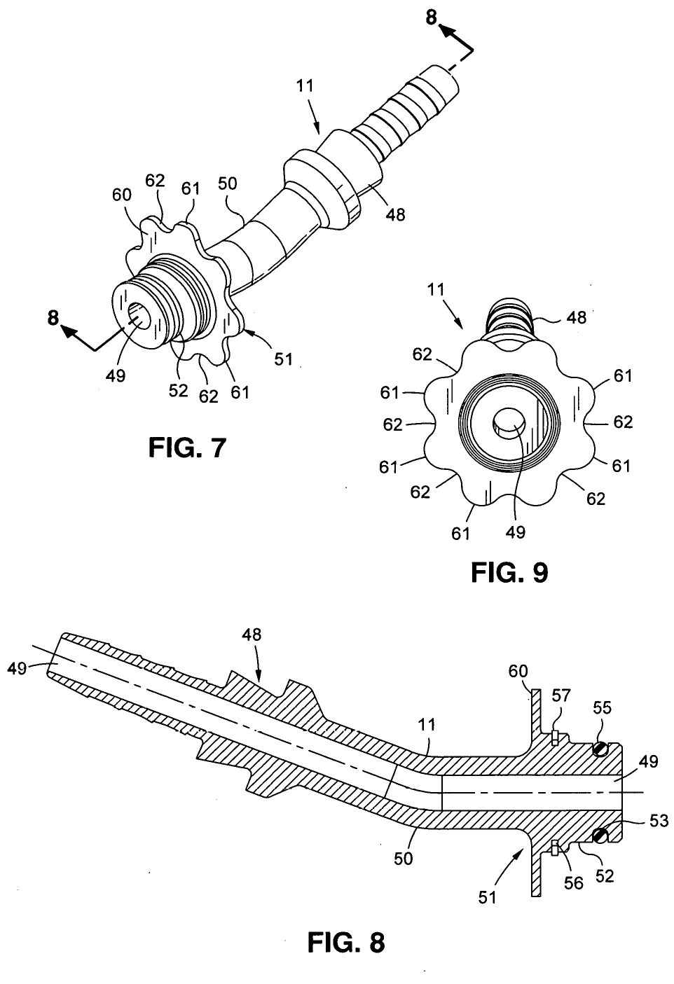

An understanding of the structure of connecting members 11, 12 and 13 can be best gained by reference to FIGS. 7, 8 and 9. Connecting members 11, 12 and 13 couple distribution housing block 10 to brake line hoses emanating from the brake fluid master cylinder and the brake calipers of a motorcycle. Although the present invention is described with the present invention's use with conventional motor cycle braking systems, it is understood the present invention may be used with anti-lock braking systems installed on newer motorcycle models. Connecting members 11, 12 and 13 are identical with the exception of the deflection angle between the ends of the brake fluid conduits. For the purpose of example only, FIGS. 7, 8 and 9 and the discussion thereof pertain to connecting member 11. Connecting members 11, 12 and 13 consist of a cylindrical fluid conduit 50 having an axial channel 48 disposed therethrough depending into connecting head 51 at one end thereof and a brake line hose receiver 49 at the opposing end of conduit 50. Brake line hose receiver 49 is adapted to receive and be secured to a conventional brake line hose (not shown) used with motorcycles. Connecting head 51 is annularly disposed about the end of conduit 50 and comprises a positioning key 60 depending into a substantially cylindrical plug member 52. Machine channel 53 is formed in plug member 52 in annular, spaced relation to channel 48 and is adapted to receive an O-ring 55. Machined channel 56 is formed in plug member 52 in annular, spaced relation to channel 48 and is adapted to receive retaining ring 57. Cylindrical plug member 52 is adapted to be received and engaged within central bore 28 and the aperture formed by cylindrical channel 25 at side panels 14 and 15. The angular deflection between cylindrical channel 49 at brake line hose receiver 48 and cylindrical channel 49 at connecting head 51 can be selected to be any angle between 0° and 90°, the deflection angle not being considered to be an element of the present invention. As shown in FIG. 1, the deflection angle in connecting member 12 is approximately 90°; the deflection angle in connecting member 13 is 0°; the deflection angle in connecting member 11 is approximately 20°. In addition, it is understood that the distance between the connecting head 51 and brake line hose receiver 48 can be any length dependent upon the installation.

The objectives of the present invention are achieved through the respective engagement of positioning key 60 of connecting members 11, 12 and 13 and receiving detents 40, 43 and 44 which will allow the user to select the optimum engagement of positioning key 60 within a receiving detent 40, 43 and 44. It is understood that the structural dimensions of receiving detents 40, 43 and 44 are identical. As can be seen in FIG. 6, receiving detents, 40, 43 and 44 are defined by a receiving surface 71 in parallel, spaced relation to top wall 18, side wall 43 and side wall 44, respectively. The configuration of receiving surface 71 is defined by peripheral surface 70. As can be seen best in FIGS. 7, 8 and 9, positioning key 60 is a planar, multi-lobular member annularly disposed about conduit 50 the adjacent cylindrical plug member 53 that comprises a first series of outwardly arcuately curved surfaces 61 and a second series of inwardly arcuately curved surfaces 62 wherein the curved surfaces of the first series alternate with the curved surfaces of the second series and are smoothly merged therewith. As a result, the surfaces 61 and 62 provide a series of alternating lobes and flutes such that the peripheral dimensions of positioning key 60 defines a multi-lobular configuration. As can be best seen in FIG. 6, receiving detent 40 comprises a multi-lobular configuration defined by peripheral surface 70 comprising a first series of arcuately curved inwardly concave surfaces 66 and a second series of convex surfaces 67 which are curved oppositely of said first series of surfaces, the first series of surfaces alternating and merging smoothly with the second series of surfaces. As a result, the maximum and minimum peripheral dimensions of peripheral surface 70 of receiving detent 40 define a multi-lobcd configuration substantially similar of that of positioning key 60. The maximum and minimum dimensions of the positioning key 60 are slightly less than the maximum and minimum dimensions of the receiving detent 40 so that positioning key 60 is fully received within receiving detent 40 with the respective lobes and flutes in mating engagement. It would be understood by persons having skill in the art to which the present invention pertains that the geometrical configuration of positioning key 60 and receiving detent 40 as defined in connection with the preferred embodiment of the present invention could be replaced by other conventional, symmetrically defined cylindrical shapes (e.g., sawtooth).

The procedure for securing connecting members 11, 12 and 13 to any of the receiving detents 40, 43 or 44 is the same. For the purpose of example only, the following description relates to the joinder of the connecting member 12 to receiving detent 40. Connecting head 51 is axially aligned with cylindrical bore 25 so that positioning key 60 is in parallel spaced relation to receiving surface 71 of receiving detent 43. Positioning key 60 is rotated about the axis of connecting head 51 to a position that will optimally engage positioning key 60 with receiving detent 43 in a manner that will position the brake line hose receiver 48 in a selected orientation that will facilitate its connection to either the brake line master cylinder or the brake calipers. Once connecting member 11 is properly positioned, positioning member 60 is engaged within the peripheral surface 70 of receiving detent 43 adjacent receiving surface 71 and is further urged inwardly until O-ring 55 is seated against O-ring receiver 42 and retaining ring 57 is secured within retaining ring seat 41. Using the features of the present invention, a brake fluid transfer system for a motorcycle can employ component parts of a common design for use with multiple motorcycle models.

I claim:

1. A brake fluid transfer assembly for use with the braking system of a motor vehicle comprising:
(a) a distribution housing block having at least two opposing outer surfaces in parallel, spaced relation to each other and a cylindrical bore disposed between the opposed outer surfaces, the axis of said cylindrical bore being perpendicular to the parallel outer surfaces of the distributing housing block, and a receiving detent disposed into each of the opposed outer surfaces of said distribution housing block symmetrically about the axis of the cylindrical bore; and
(b) first and second cylindrical connecting members each having first and second ends and an axial conduit disposed therethrough, the first end of each connecting member depending into a brake hose receiver adapted to be coupled to the braking system of the motor vehicle, the second end of each connecting member depending into a connecting head adapted to be engaged within a cylindrical bore at an outer surface of the distribution housing block, and positioning means for selectively orienting each connecting member with respect to the receiving detent disposed about the connecting head perpendicular to the axial conduit.

2. A brake fluid transfer assembly as set forth in claim 1 wherein said distributing housing block comprises a cuboid having at least first and second pairs of opposing outer surfaces, each pair of opposing outer surfaces being in parallel, spaced relation to each other, the first pair of opposing outer surfaces being perpendicular to the second pair of opposing outer surfaces.

3. A brake fluid transfer assembly as described in claim 2 wherein a cylindrical channel is disposed through an outer surface of the distribution housing block perpendicular to the outer surface and the axis of the cylindrical bore, said cylindrical channel being connected to and in communication with said cylindrical bore.

4. A brake fluid transfer assembly as described in claim 1 wherein the first and second ends of the conduit being angularly deflected from each other within a range of 0°-90° of arc.

5. A brake fluid transfer assembly as described in claim 1 wherein the receiving detent comprises a depressed planar surface perpendicular to and symmetrically disposed about the axis of the cylindrical bore, the planar surface being bounded by a periphery perpendicular to the planar surface having a non-constant radial dimension from the axis of the cylindrical bore including a minimum radial dimension and a maximum radial dimension.

6. A brake fluid transfer assembly as described in claim 5 wherein the positioning means comprises a positioning key consisting of planar member perpendicular to the conduit and uniformly disposed about the axis of the conduit and having a peripheral surface, the dimensions of which correspond to the peripheral dimensions of the receiving detent, the planar member and the receiving detent co-acting to prevent rotation of the planar member within the receiving detent.

7. A brake fluid transfer assembly as described in claim 6 wherein the periphery of the receiving detent and the positioning key are multi-lobular.

8. A brake fluid transfer assembly as described in claim 7 wherein said multi-lobular peripheries of said receiving detent and said positioning key comprise a series of projections defined by a first series of arcuately curved surfaces and a second series of surfaces curved oppositely of said first series and alternating therewith by merging smoothly with said first series, said projections serving, upon said projection key being received within the receiving detent, to prevent relative motion between the distribution housing block and the connecting member.

9. A brake fluid transfer assembly for use with the braking system of a motor vehicle comprising:
(a) a distribution housing block having at least first and second pairs of opposed outer surfaces, each pair of opposed outer surfaces being in parallel, spaced relation to each other, the first pair of opposed outer surfaces being perpendicular to the second pair of opposed outer surfaces, a cylindrical bore being disposed between the first pair of opposed outer surfaces, the axis of said cylindrical bore being perpendicular to the first pair of opposed outer surfaces, a cylindrical channel being disposed through an outer surface of the second pair of opposed outer surfaces perpendicular to the second pair of opposed outer surfaces and the axis of the cylindrical bore, said cylindrical channel being connected to and in communication with said cylindrical bore, and a receiving detent disposed into the first pair of opposed outer surfaces of said distribution housing block symmetrically about the axis of the cylindrical bore and disposed in the opposed outer surface of said second pair of opposed outer surfaces symmetrically about the axis of the cylindrical cylinder;
(b) first and second cylindrical connecting members each having first and second ends and an axial conduit disposed therethrough, the first end of each connecting member depending into a brake hose receiver adapted to be coupled to the braking system of the motor vehicle, the second end of each connecting member depending into a connecting head adapted to be engaged within a cylindrical bore and a cylindrical channel at an outer surface of the distribution housing block, the first and second ends of the axial conduit being angularly deflected from each other within a range of 0° to 90° of arc, and positioning means for selectively orienting each connecting member with respect to the receiving detent disposed about the connecting head perpendicular to the axial conduit.

10. A brake fluid transfer assembly as described in claim 9 wherein each receiving detent comprises a depressed planar surface perpendicular to and symmetrically disposed about the axis of the cylindrical bore and the axis of the cylindrical channel, the planar surface being bounded by a periphery perpendicular to the planar surface having a non-constant radial dimension from the axis of the cylindrical bore and the cylindrical channel including a minimum radial dimension and a maximum radial dimension.

11. A brake fluid transfer assembly as described in claim 10 wherein the positioning means comprises a positioning key consisting of planar member perpendicular to and uniformly disposed about the axial conduit and having a peripheral surface, the dimensions of which correspond to the peripheral dimensions of the receiving detents, each planar member and the respective receiving detent co-acting to prevent rotation of a planar member within a receiving detent.

12. A brake fluid transfer assembly as described in claim 11 wherein the periphery of each receiving detent and the respective positioning key are multi-lobular.

13. A brake fluid transfer assembly as described in claim 12 wherein said multi-lobular peripheries of said receiving detents and said respective positioning keys comprise a series of projections defined by a first series of arcuately curved surfaces and a second series of surfaces curved oppositely of said first series and alternating therewith by merging smoothly with said first series, said projections serving, upon said projection key being received within the receiving detent, to prevent relative motion between the distribution housing block and the connecting members.
